(19) United States
(12) Patent Application Publication
(10) Pub. No.: US 2026/0072836 A1
(43) Pub. Date: Mar. 12, 2026

(54) MINIMIZING EFFECTS OF CACHE THRASHING BY ALTERING A PERSISTENCE POLICY FOR NON-TEMPORAL WORKLOADS

(71) Applicant: International Business Machines Corporation, Armonk, NY (US)

(72) Inventors: Robert J Sonnelitter, III, Bedford Hills, NY (US); Craig R Walters, Highland, NY (US); Avery Francois, East Schodack, NY (US)

(21) Appl. No.: 18/883,172

(22) Filed: Sep. 12, 2024

(51) Int. Cl. G06F 12/0802

(52) U.S. Cl. CPC G06F 12/0802; G06F 12/0888; G06F 2212/60

(57) ABSTRACT

implemented method, system, and computer program product for minimizing the effects of cache thrashing involving non-temporal workloads. The cache activities of a workload, including the cache activities (e.g., number of cache hits) involving local and peer caches, are monitored. Based on analyzing the metrics of such monitored cache activities, a determination is made as to whether a non-temporal workload is identified. For example, such a determination may be based on comparing the metrics of the monitored cache activities of the workload to a threshold value. Upon identifying a non-temporal workload, the cache line(s) associated with the non-temporal workload are identified. The persistence policy for the identified cache line(s) is then altered. For example, the persistence policy for the identified cache line(s) may be altered by reducing the tenure of such a cache line(s) thereby reducing the number of cache misses or evictions and minimizing the effects of cache thrashing.

### TECHNICAL FIELD

The present disclosure relates generally to cache thrashing, and more particularly to minimizing the effects of cache thrashing by altering a persistence policy for non-temporal workloads.

### BACKGROUND

Cache thrashing is a flaw in caching mechanisms that occurs when a cache (e.g., CPU cache) is constantly updated with new data or repeatedly accesses data that is larger than the cache size. This can lead to frequent cache misses or data evictions, which forces the processor to access the slower main memory more often. This can negatively impact the processor's performance and efficiency.

Cache thrashing may occur when workloads stream large amounts of data from memory. A workload refers to the computational tasks, processes, or data transactions required to be performed by a program. Examples of such workloads that stream large amounts of data from memory include streaming real-time data, such as location, stock prices, information technology system monitoring, fraud detection, retail inventory, sales, customer activity, etc.

Workloads that stream large amounts of data from memory (e.g., main memory) may negatively impact the overall system performance by thrashing multiple cache levels, such as by constantly updating a cache with new data or repeatedly accessing data that is larger than the cache size. As a result, the number of cache misses or data evictions may increase thereby resulting in the processor accessing the slower main memory to fetch the requested data.

Furthermore, such workloads may consume system resources to persist data (referring to storing data in a cache for a period of time) in the cache that will not be re-referenced. As a result, the number of cache misses or data evictions may increase thereby resulting in the processor accessing the slower main memory to fetch the requested data.

Techniques have been developed to attempt to address cache thrashing. For example, one such technique is to use different cache levels or partitions to reduce cache contention.

In another example, the cache size is attempted to be optimized. For instance, after determining the cache size, large amounts of data is split into smaller blocks that can fit inside the cache.

Another technique is to optimize the cache replacement policy, such as by matching the policy to the workload.

Furthermore, a cache-aside pattern may be used to address cache thrashing. For example, a microservice check may be used to determine if data is available in the cache before accessing it.

Despite these techniques to address cache thrashing, such techniques do not address the effects of cache thrashing involving the situation when workloads stream large amounts of data from memory (e.g., main memory) which negatively impacts the overall system performance by thrashing multiple cache levels and consuming system resources by persisting data in the cache that will not re-referenced.

### SUMMARY

In one embodiment of the present disclosure, a computer-implemented method for minimizing effects of cache thrashing comprises monitoring cache activity of a workload. The method further comprises identifying a non-temporal workload based on the monitored cache activity of the workload. The method additionally comprises identifying one or more cache lines associated with the non-temporal workload. Furthermore, the method comprises altering a persistence policy for the one or more cache lines associated with the non-temporal workload.

Other forms of the embodiment of the computer-implemented method described above are in a system and in a computer program product.

Accordingly, embodiments of the present disclosure minimize the effects of cache thrashing from a non-temporal workload.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates an embodiment of the present disclosure of a computing environment for practicing the principles of the present disclosure;

FIG. 2 illustrates a distributed symmetric multiprocessing (SMP) system utilizing cache persistence in accordance with an embodiment of the present disclosure;

FIG. 3 is a diagram of the software components used by the cache controller to minimize the effects of cache thrashing involving a non-temporal workload in accordance with an embodiment of the present disclosure; and

FIG. 4 is a flowchart of a method for minimizing the effects of cache thrashing involving a non-temporal workload in accordance with an embodiment of the present disclosure.

### DETAILED DESCRIPTION

In one embodiment of the present disclosure, a computer-implemented method for minimizing effects of cache thrashing comprises monitoring cache activity of a workload. The method further comprises identifying a non-temporal workload based on the monitored cache activity of the workload. The method additionally comprises identifying one or more cache lines associated with the non-temporal workload. Furthermore, the method comprises altering a persistence policy for the one or more cache lines associated with the non-temporal workload.

In this manner, the effects of cache thrashing from a non-temporal workload are minimized.

Additionally, in one embodiment of the present disclosure, the persistence policy is altered to reduce a tenure of the one or more cache lines.

In this manner, the effects of cache thrashing from a non-temporal workload are minimized by reducing the length of time that the cache line(s) associated with the non-temporal workload are stored.

Furthermore, in one embodiment of the present disclosure, the persistence policy is altered to reduce the tenure of the one or more cache lines via setting a particular value in a hint bit.

In this manner, the effects of cache thrashing from a non-temporal workload are minimized by reducing the length of time that the cache line(s) associated with the non-temporal workload are stored via hint bits.

Additionally, in one embodiment of the present disclosure, the persistence policy is altered to cast-out the one or more cache lines directly to memory.

In this manner, the effects of cache thrashing from a non-temporal workload are minimized by casting out the cache line(s) associated with the non-temporal workload to memory.

Furthermore, in one embodiment of the present disclosure, method additionally comprises analyzing metrics of the monitored cache activity of the workload.

In this manner, a non-temporal workload is identified based on analyzing the metrics of the monitored cache activity of the workload.

Additionally, in one embodiment of the present disclosure, the metrics of the monitored cache activity of the workload comprise one or more of the following selected from the group consisting of: cache hit/miss ratio, cache miss data sources, fetch/cast-out ratio, and percentage of cast-outs with changed data.

In this manner, a non-temporal workload is identified based on analyzing the cache hit/miss ratio, the cache miss data sources, the fetch/cast-out ratio, and/or the percentage of cast-outs with changed data of the monitored cache activity of the workload.

Furthermore, in one embodiment of the present disclosure, the cache activity of the workload is monitored in connection with a peer cache, where the metrics of the monitored cache activity of the workload comprise a cast-in/fetch-hit ratio provided by the peer cache.

In this manner, a non-temporal workload is identified based on monitoring the cache activity provided by a peer cache, such as the cast-in/fetch-hit ratio.

Additionally, in one embodiment of the present disclosure, the cache activity of the workload is monitored in connection with local caches and peer caches.

In this manner, a non-temporal workload is identified based on the cache activity metrics of the local and peer caches.

Furthermore, in one embodiment of the present disclosure, the workload streams data from a memory.

In this manner, a non-temporal workload that streams data from a memory may be identified.

As stated above, cache thrashing may occur when workloads stream large amounts of data from memory. A workload refers to the computational tasks, processes, or data transactions required to be performed by a program. Examples of such workloads that stream large amounts of data from memory include streaming real-time data, such as location, stock prices, information technology system monitoring, fraud detection, retail inventory, sales, customer activity, etc.

Workloads that stream large amounts of data from memory (e.g., main memory) may negatively impact the overall system performance by thrashing multiple cache levels, such as by constantly updating a cache with new data or repeatedly accessing data that is larger than the cache size. As a result, the number of cache misses or data evictions may increase thereby resulting in the processor accessing the slower main memory to fetch the requested data.

Furthermore, such workloads may consume system resources to persist data (referring to storing data in a cache for a period of time) in the cache that will not be re-referenced. As a result, the number of cache misses or data evictions may increase thereby resulting in the processor accessing the slower main memory to fetch the requested data.

Techniques have been developed to attempt to address cache thrashing. For example, one such technique is to use different cache levels or partitions to reduce cache contention.

In another example, the cache size is attempted to be optimized. For instance, after determining the cache size, large amounts of data is split into smaller blocks that can fit inside the cache.

Another technique is to optimize the cache replacement policy, such as by matching the policy to the workload.

Furthermore, a cache-aside pattern may be used to address cache thrashing. For example, a microservice check may be used to determine if data is available in the cache before accessing it.

Despite these techniques to address cache thrashing, such techniques do not address the effects of cache thrashing involving the situation when workloads stream large amounts of data from memory (e.g., main memory) which negatively impacts the overall system performance by thrashing multiple cache levels and consumes system resources to persist data in the cache that will not re-referenced.

The embodiments of the present disclosure provide a means for minimizing the effects of cache thrashing by altering a persistence policy for non-temporal workloads. In one embodiment, cache activity metrics for local and peer caches are monitored and analyzed for determining if the workload that is streaming data from the memory is a non-temporal workload. A “non-temporal workload,” as used herein, refers to a workload that persists data that is not going to be reused (read again) soon, such as before it gets evicted (cast-out). As a result, there is no benefit in persisting such data in the cache(s) and there may be a penalty if the stored data displaces other useful data from the cache(s). In one embodiment, such a non-temporal workload may be identified based on analyzing cache activity metrics for local and peer caches, such as the cache hit/miss ratio, the cache miss data sources, the fetch/cast-out ratio, and the percentage of cast-outs with changed data. For example, the lower the cache hit/miss ratio, the higher the fetch/cast-out ratio, and the higher the percentage of cast-outs with changed data (casting out a changed data item results in reading the changed data item from the cache structure and writing it to permanent storage without deleting the data item from the cache structure), the more likely that the data being persisted in the cache corresponds to non-temporal workload data. Furthermore, cache miss data sources may indicate that the data being stored in the cache(s) corresponds to non-temporal data from a non-temporal workload. For instance, an algorithm that performs transformations on data streams, such as reading the data once from one location and writing it once to another location, may result in no data reuses. In another example, an algorithm that runs on a data set that does not fit in the cache will result in no data reuses. Upon determining that the workload that is streaming data from the memory is a non-temporal workload, the cache line(s) associated with the non-temporal workload are identified. A cache line, as used herein, refers to a block of memory that a processor loads into a cache when it accesses a part of memory that is not already stored in the cache. The cache line contains the actual data that was fetched from the main memory, as well as a directory store, status information, and an effective memory address. The persistence policy for the cache line(s) associated with the non-temporal workload may then be altered to minimize the cache thrashing effects, such as by reducing the tenure (length of time data is stored in the cache) of the cache line(s) or casting out the cache line(s) directly to memory. In this manner, the effects of cache thrashing involving non-temporal workloads are minimized. A further description of these and other features will be provided below.

In some embodiments of the present disclosure, the present disclosure comprises a computer-implemented method, system, and computer program product for minimizing the effects of cache thrashing involving non-temporal workloads. In one embodiment of the present disclosure, the cache activities of a workload, including the cache activities involving local and peer caches, are monitored. Examples of such activities include the number of cache hits and cache misses for a cache, the number of fetches and cast-outs, the amount of data the cache has downloaded but did not add to its cache, etc. Based on analyzing the metrics of such monitored cache activities, a determination is made as to whether a non-temporal workload is identified. A “non-temporal workload,” as used herein, refers to a workload that persists data that is not going to be reused (read again) soon, such as before it gets evicted (cast-out). As a result, there is no benefit in persisting such data in the cache(s) and there may be a penalty if the stored data displaces other useful data from the cache(s). In one embodiment, such a determination is based on comparing the metrics of the monitored cache activities of the workload to a threshold value, which may be user-designated. For example, the cache hit/miss ratio, the fetch/cast-out ratio, and/or the percentage of cast-outs with changed data may be compared against a threshold value, which may be user-designated. For instance, if the cache his/miss ratio is below a threshold value, then it may be inferred that the workload corresponds to a non-temporal workload. Upon identifying a non-temporal workload, the cache line(s) associated with the non-temporal workload are identified. The persistence policy for the identified cache line(s) is then altered. A persistence policy, as used herein, defines the rules used to determine how long data or a cache line can be persisted or stored in a cache. In one embodiment, the persistence policy for the cache line(s) associated with the non-temporal workload is altered by reducing the tenure (length of time data is stored in the cache) of such a cache line(s) in the cache. By reducing the length of time the cache line(s) associated with non-temporal workloads are stored in the cache, such a cache will not be persisting data that will not be re-referenced for a great amount of time thereby reducing the number of cache misses or evictions. By reducing the number of cache misses or evictions, the effects of cache thrashing are minimized. In another embodiment, the persistence policy for the cache line(s) associated with the non-temporal workload is altered by casting-out (evicting) the cache line(s) associated with the non-temporal workload. By casting out the cache line(s) from the cache associated with the non-temporal workload, such a cache will not be storing data that will not be re-referenced thereby reducing the number of cache misses or evictions. By reducing the number of cache misses or evictions, the effects of cache thrashing are minimized. In this manner, the effects of cache thrashing from a non-temporal workload are minimized.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill in the relevant art.

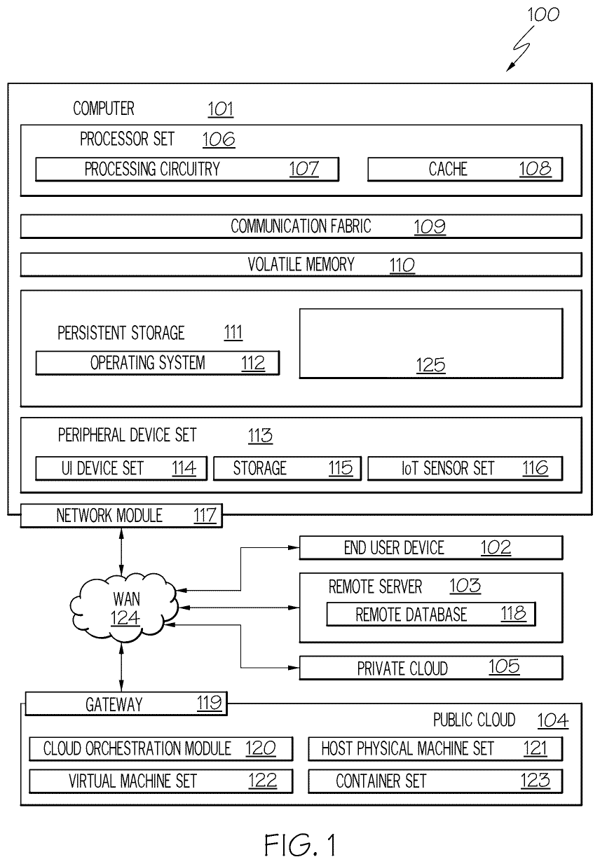

Referring now to the Figures in detail, FIG. 1 illustrates an embodiment of the present disclosure of a computing environment 100 for practicing the principles of the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code (stored in block 125) involved in performing the inventive methods, such as minimizing the effects of cache threshing involving non-temporal workloads. In addition to block 125, computing environment 100 includes, for example, computer 101, network 124, such as a wide area network (WAN), end user device (EUD) 102, remote server 103, public cloud 104, and private cloud 105. In this embodiment, computer 101 includes processor set 106 (including processing circuitry 107 and cache 108), communication fabric 109, volatile memory 110, persistent storage 111 (including operating system 112 and block 125, as identified above), peripheral device set 113 (including user interface (UI) device set 114, storage 115, and Internet of Things (IoT) sensor set 116), and network module 117. Remote server 103 includes remote database 118. Public cloud 104 includes gateway 119, cloud orchestration module 120, host physical machine set 121, virtual machine set 122, and container set 123.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 118. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 106 includes one, or more, computer processors of any type now known or to be developed in the future. Processing circuitry 107 may be distributed over multiple packages, for example, multiple, coordinated integrated circuit chips. Processing circuitry 107 may implement multiple processor threads and/or multiple processor cores. Cache 108 is memory that is located in the processor chip package(s) and is typically used for data or code that should be available for rapid access by the threads or cores running on processor set 106. Cache memories are typically organized into multiple levels depending upon relative proximity to the processing circuitry. Alternatively, some, or all, of the cache for the processor set may be located “off chip.” In some computing environments, processor set 106 may be designed for working with qubits and performing quantum computing.

Computer readable program instructions are typically loaded onto computer 101 to cause a series of operational steps to be performed by processor set 106 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 108 and the other storage media discussed below. The program instructions, and associated data, are accessed by processor set 106 to control and direct performance of the inventive methods. In computing environment 100, at least some of the instructions for performing the inventive methods may be stored in block 125 in persistent storage 111.

Communication fabric 109 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 110 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 110 is located in a single package and is internal to computer 101, but, alternatively or additionally, the volatile memory may be distributed over multiple packages and/or located externally with respect to computer 101.

Persistent Storage 111 is any form of non-volatile storage for computers that is now known or to be developed in the future. The non-volatility of this storage means that the stored data is maintained regardless of whether power is being supplied to computer 101 and/or directly to persistent storage 111. Persistent storage 111 may be a read only memory (ROM), but typically at least a portion of the persistent storage allows writing of data, deletion of data and re-writing of data. Some familiar forms of persistent storage include magnetic disks and solid state storage devices. Operating system 112 may take several forms, such as various known proprietary operating systems or open source Portable Operating System Interface type operating systems that employ a kernel. The code included in block 125 typically includes at least some of the computer code involved in performing the inventive methods.

Peripheral device set 113 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 114 may include components such as a display screen, speaker, microphone, wearable devices (such as goggles and smart watches), keyboard, mouse, printer, touchpad, game controllers, and haptic devices. Storage 115 is external storage, such as an external hard drive, or insertable storage, such as an SD card. Storage 115 may be persistent and/or volatile. In some embodiments, storage 115 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 116 is made up of sensors that can be used in Internet of Things applications. For example, one sensor may be a thermometer and another sensor may be a motion detector.

Network module 117 is the collection of computer software, hardware, and firmware that allows computer 101 to communicate with other computers through WAN 124. Network module 117 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 117 are performed on the same physical hardware device. In other embodiments (for example, embodiments that utilize software-defined networking (SDN)), the control functions and the forwarding functions of network module 117 are performed on physically separate devices, such that the control functions manage several different network hardware devices. Computer readable program instructions for performing the inventive methods can typically be downloaded to computer 101 from an external computer or external storage device through a network adapter card or network interface included in network module 117.

WAN 124 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 102 is any computer system that is used and controlled by an end user (for example, a customer of an enterprise that operates computer 101), and may take any of the forms discussed above in connection with computer 101. EUD 102 typically receives helpful and useful data from the operations of computer 101. For example, in a hypothetical case where computer 101 is designed to provide a recommendation to an end user, this recommendation would typically be communicated from network module 117 of computer 101 through WAN 124 to EUD 102. In this way, EUD 102 can display, or otherwise present, the recommendation to an end user. In some embodiments, EUD 102 may be a client device, such as thin client, heavy client, mainframe computer, desktop computer and so on.

Remote server 103 is any computer system that serves at least some data and/or functionality to computer 101. Remote server 103 may be controlled and used by the same entity that operates computer 101. Remote server 103 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 118 of remote server 103.

Public cloud 104 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 104 is performed by the computer hardware and/or software of cloud orchestration module 120. The computing resources provided by public cloud 104 are typically implemented by virtual computing environments that run on various computers making up the computers of host physical machine set 121, which is the universe of physical computers in and/or available to public cloud 104. The virtual computing environments (VCEs) typically take the form of virtual machines from virtual machine set 122 and/or containers from container set 123. It is understood that these VCEs may be stored as images and may be transferred among and between the various physical machine hosts, either as images or after instantiation of the VCE. Cloud orchestration module 120 manages the transfer and storage of images, deploys new instantiations of VCEs and manages active instantiations of VCE deployments. Gateway 119 is the collection of computer software, hardware, and firmware that allows public cloud 104 to communicate through WAN 124.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 105 is similar to public cloud 104, except that the computing resources are only available for use by a single enterprise. While private cloud 105 is depicted as being in communication with WAN 124 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 104 and private cloud 105 are both part of a larger hybrid cloud.

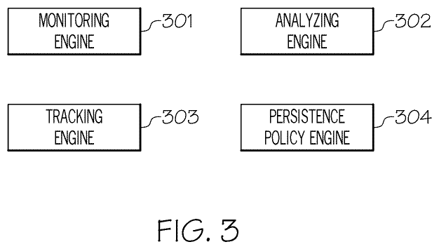

Block 125 further includes the software components discussed herein in connection with FIG. 3 to minimize the effects of cache thrashing involving non-temporal workloads. In one embodiment, such components may be implemented in hardware. The functions discussed above performed by such components are not generic computer functions. As a result, computer 101 is a particular machine that is the result of implementing specific, non-generic computer functions.

In one embodiment, the functionality of such software components of computer 101, including the functionality for minimizing the effects of cache threshing involving non-temporal workloads, may be embodied in an application specific integrated circuit.

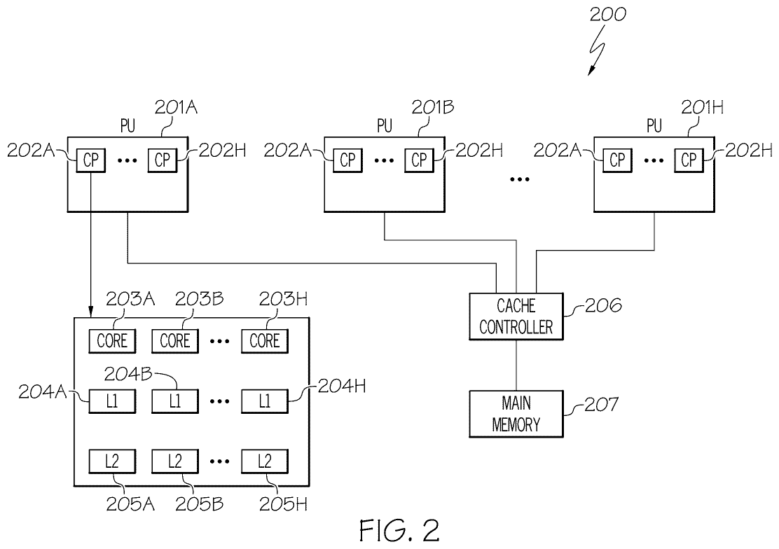

An embodiment of computer 101 implementing a distributed symmetric multiprocessing (SMP) system utilizing cache persistence is discussed below in connection with FIG. 2.

FIG. 2 illustrates a distributed symmetric multiprocessing (SMP) system 200 utilizing cache persistence in accordance with an embodiment of the present disclosure. In one embodiment, such a system 200 corresponds to processing circuitry 107, cache 108 of computer 101.

Referring now to FIG. 2, SMP system 200 includes processing units (“PUs”) 201A-201H. Processing units 201A-201H may collectively or individually be referred to as processing units (PUs) 201 or processing unit (PU) 201, respectively.

In one embodiment, each processing unit 201 includes eight (8) microprocessor (CP) chips 202A-202H. CP chips 202A-202H may collectively or individually be referred to as CP chips 202 or CP chip 202, respectively. In one embodiment, CP chip 202 corresponds to a single semiconductor chip that integrates the functional units of a computer, such as the arithmetic/logic, control, storage, input, and output.

In one embodiment, each CP chip 202 includes eight (8) cores 203A-203H. Cores 203A-203H may collectively or individually be referred to as cores 203 or core 203, respectively. In one embodiment, core 203 corresponds to a component of the computer's processing unit (e.g., PU 201) that executes instructions and processes data.

In one embodiment, each CP chip 202 further includes L1 (level one) caches 204A-204H (including both instruction cache and data cache). In one embodiment, L1 caches 204A-204H are backed by L2 (level two) caches 205A-205H. L1 caches 204A-204H may collectively or individually be referred to as L1 caches 204 or L1 cache 204, respectively. L2 caches 205A-205H may collectively or individually be referred to as L2 caches 205 or L2 cache 205, respectively. In one embodiment, L2 caches 205 interact to provide an on-chip virtual L3 (level three) cache. In one embodiment, each PU 201 contains up to 8 CP chips 202 with a fully connected topology providing a virtual L4 (level four) cache. The virtual L3 and virtual L4 caches can be implemented through a set of chip caching technologies that cluster the independent physical L2 caches 205 within CP chip 202 and within PU 201 to act as a unified shared victim cache.

In one embodiment, the virtual L3/L4 caches are implemented by defining groups/clusters of L2 caches 205 within CP chip 202, a group of CP chips 202, and/or PUs 201 for evicting cache lines from peer caches. That is to say, a cache line is evicted from a first L2 cache 205 to a peer L2 cache 205 within the defined groups/clusters of L2 caches 205 according to a defined replacement policy. A “peer cache” (also referred to as a “lateral cache”), as used herein, refers to a cache, that is used to persist data (e.g.,. cache line) that was evicted or cast-out from another cache. For example, such peer caches may be divided in a cluster of caches (e.g., L2 caches 205A-205H in CP 202A of PU 201A form a first cluster and L2 caches 205A-205H in CP 202A of PU 201B form a second cluster), where a cache line in a cache (e.g., L2 cache 205A in CP 202A of PU 201A) is evicted to a peer cache (e.g., L2 cache 205A in CP 202A in PU 201B) in a cluster to be persisted. If such a cache line is further evicted, then the cache line may be further persisted in another cluster until the evicted cache line reaches a last cluster and can be evicted to main memory 207 (e.g., memory 110 of FIG. 1).

Evicting (also referred to as cast-out), as used herein, refers to removing a cache line from a cache (e.g., L2 cache 205A). A cache line, as used herein, refers to a block of memory that a processor loads into a cache when it accesses a part of memory that is not already stored in the cache. The cache line contains the actual data that was fetched from the main memory, as well as a directory store, status information, and an effective memory address.

Furthermore, as shown in FIG. 2, system 200 includes a cache controller 206 connected to PUs 201 and main memory 207. In one embodiment, the lateral persistence and replacement policy is implemented using cache controller 206 to manage cache evictions amongst the clusters of caches and evictions to main memory 207. In one embodiment, cache controller 206 can be local within PU 201 or may be a distributed element within an instance per cluster of caches.

In one embodiment, cache controller 206 is configured to minimize the effects of cache threshing involving non-temporal workloads. In one embodiment, cache controller 206 monitors and analyzes the cache activity metrics for local and peer caches (e.g., L1 caches 204, L2 caches 205) for determining if the workload that is streaming data from the memory (e.g., main memory 207) is a non-temporal workload. A “non-temporal workload,” as used herein, refers to a workload that persists data that is not going to be reused (read again) soon, such as before it gets evicted (cast-out). As a result, there is no benefit in persisting such data in the cache(s) and there may be a penalty if the stored data displaces other useful data from the cache(s).

In one embodiment, such a non-temporal workload may be identified based on analyzing cache activity metrics for local and peer caches (e.g., L1 caches 204, L2 caches 205), such as the cache hit/miss ratio, cache miss data sources, the fetch/cast-out ratio, and the percentage of cast-outs with changed data. For example, the lower the cache hit/miss ratio, the higher the fetch/cast-out ratio, and the higher the percentage of cast-outs with changed data (casting out a changed data item results in reading the changed data item from the cache structure and writing it to permanent storage without deleting the data item from the cache structure), the more likely that the data being persisted in the cache corresponds to non-temporal workload data. Furthermore, cache miss data sources may indicate that the data being stored in the cache(s) corresponds to non-temporal data from a non-temporal workload. For instance, an algorithm that performs transformations on data streams, such as reading the data once from one location and writing it once to another location, may result in no data reuses. In another example, an algorithm that runs on a data set that does not fit in the cache will result in no data reuses.

Upon determining that the workload that is streaming data from the memory is a non-temporal workload, cache controller 206 identifies the cache line(s) associated with the non-temporal workload. A cache line, as used herein, refers to a block of memory that a processor loads into a cache when it accesses a part of memory that is not already stored in the cache. The cache line contains the actual data that was fetched from the main memory (e.g., main memory 207), as well as a directory store, status information, and an effective memory address.

In one embodiment, in response to determining that the workload that is streaming data from the memory is a non-temporal workload, cache controller 206 alters the persistence policy for the cache line(s) associated with the non-temporal workload to minimize the cache thrashing effects, such as by reducing the tenure (length of time data is stored in the cache) of the cache line(s) or casting out the cache line(s) directly to main memory 207.

A discussion regarding the software components used by cache controller 206 to minimize the effects of cache thrashing involving a non-temporal workload is provided below in connection with FIG. 3.

FIG. 3 is a diagram of the software components used by cache controller 206 to minimize the effects of cache thrashing involving a non-temporal workload in accordance with an embodiment of the present disclosure.

Referring to FIG. 3, in conjunction with FIGS. 1-2, cache controller 206 includes monitoring engine 301 configured to monitor the cache activities of a workload as well as obtain measurements of such monitored cache activities. In one embodiment, monitoring engine 301 monitors the cache activities and obtains measurements of such monitored cache activities for local and peer caches (e.g., L1 cache 204, L2 cache 205).

A workload, as used herein, refers to the computational tasks, processes, or data transactions required to be performed by a program. Such tasks may correspond to streaming data from main memory 207. If the fetched data from main memory 207 is not already stored in the cache, and such data may likely be accessed in the near future, then a cache line containing the actual data that was fetched from main memory 207 is loaded into a cache (e.g., L1 cache 204, L2 cache 205) for future access. A cache line, as used herein, refers to a block of memory that a processor loads into a cache when it accesses a part of memory that is not already stored in the cache. The cache line contains the actual data that was fetched from main memory 207, as well as a directory store, status information, and an effective memory address.

In one embodiment, various cache activities are monitored and measured by monitoring engine 301, such as the data served, which corresponds to the total amount of data the cache (e.g., L1 cache 204, L2 cache 205) has served. Another example of a monitored and measured cache activity includes the amount of data the cache (e.g., L1 cache 204, L2 cache 205) has downloaded but did not add to its cache. A further example of a monitored and measured cache activity includes the data served from the origin, such as the amount of data the cache (e.g., L1 cache 204, L2 cache 205) downloaded over the Internet. Furthermore, a monitored and measured cache activity may include the data served from peers, such as the amount of data the cache (e.g., L1 cache 204, L2 cache 205) downloaded from any of its peer caches. Another example of cache activity that is monitored and measured includes the data served to clients, which may correspond to the amount of data the cache (e.g., L1 cache 204, L2 cache 205) served to the client computers/devices. A further example of cache activity that is monitored and measured includes the data served to peers, which may correspond to the amount of data served to any of its peer caches. An additional example of cache activity includes cache pressure, which corresponds to how urgently the cache (e.g., L1 cache 204, L2 cache 205) needs more disk space.

Other examples of cache activities that are monitored and measured by monitoring engine 301 include the number of cache hits and cache misses for a cache (e.g., L1 cache 204). A cache hit, as used herein, refers to when a cache can fulfill a request for data rather than having to retrieve the data, such as from main memory 207. That is, when there is a cache hit, the data is already stored in the cache and can be quickly and efficiently served to the user. A cache miss, as used herein, refers to when there is a request to retrieve data from a cache, but the requested data does not currently reside within the cache. Furthermore, in one embodiment, in connection with monitoring cache misses, monitoring engine 301 identifies the data sources of cache misses. Upon detecting a cache miss, monitoring engine 301 may utilize various software tools to identify the data sources of the cache misses, which can include, but are not limited to, Perf tool in Linux®, VTune®, etc.

Another example of a cache activity that is monitored and measured by monitoring engine 301 includes monitoring and measuring the number of fetches and cast-outs. A fetch, as used herein, refers to retrieving data from a source, such as main memory 207. A cast-out, as used herein, refers to evicting, removing, or flushing the data, including a cache line, from the cache, which may be written to memory (e.g., main memory 207). Furthermore, in one embodiment, monitoring engine 301 monitors and measures the percentage of cast-outs with change data. Casting out a changed data item refers to reading it from the cache (e.g., L1 cache 204) and writing it to memory (e.g., main memory 207). However, when you cast-out the data item from the cache (e.g., L1 cache 204), the data item is not deleted from the cache (e.g., L1 cache 204), but the data item remains in the cache (e.g., L1 cache 204).

Other examples of cache activities that are monitored and measured by monitoring engine 301 include cast-ins and fetch-hits. A cast-in, as used herein, refers to loading data, including a cache line, into the cache (e.g., L1 cache 204). A fetch-hit, as used herein, refers to a fetch call to fetch or retrieve data from a cache (e.g., L1 cache 204) resulting in a cache hit.

In one embodiment, monitoring engine 301 monitors and measures the various cache activities discussed above using various software tools, which can include, but are not limited to, Apple® Activity Monitor, IBM® Integrated Analytics System, Amazon® ElastiCache®, Perf tool in Linux®, VTune®, etc.

Cache controller 206 further includes analyzing engine 302 configured to analyze the measurements or metrics of the monitored cache activity of the workload.

In one embodiment, analyzing engine 302 performs an analysis of the metrics of the monitored cache activity of the workload to determine if the workload is non-temporal. A “non-temporal workload,” as used herein, refers to a workload that persists data that is not going to be reused (read again) soon, such as before it gets evicted (cast-out). As a result, there is no benefit in persisting such data in the cache(s) and there may be a penalty if the stored data displaces other useful data from the cache(s). In one embodiment, such a non-temporal workload may be identified based on analyzing cache activity metrics for local and peer caches, such as the cache hit/miss ratio, the cache miss data sources, the fetch/cast-out ratio, and the percentage of cast-outs with changed data.

The cache hit/miss ratio refers to the ratio of cache hits to cache misses for the cache in question (e.g., L1 cache 204). The cache miss data sources refer to the data sources of the cache misses that were identified by monitoring engine 301. The fetch/cast-out ratio refers to the ratio of fetches to cast-outs for the cache in question. The percentage of cast-outs with changed data refers to the percentage of cast-outs that involved changed data.

As discussed above, the analysis of such metrics may indicate if the workload is a non-temporal workload. For example, the lower the cache hit/miss ratio, the higher the fetch/cast-out ratio, and the higher the percentage of cast-outs with changed data (casting out a changed data item results in reading the changed data item from the cache structure and writing it to permanent storage without deleting the data item from the cache structure), the more likely that the data being persisted in the cache corresponds to non-temporal workload data. Furthermore, cache miss data sources may indicate that the data being stored in the cache(s) (e.g., L1 cache 204) corresponds to non-temporal data from a non-temporal workload. For instance, an algorithm that performs transformations on data streams, such as reading the data once from one location and writing it once to another location, may result in no data reuses. In another example, an algorithm that runs on a data set that does not fit in the cache will result in no data reuses.

Furthermore, in one embodiment, the analysis of the metrics of the monitored cache activity of the workload to determine if the workload is non-temporal may include metrics resulting from feedback provided from peer caches, such as cast-ins and fetch-hits. Such metrics may be analyzed by analyzing engine 302 in the form of a cast-in/fetch-hit ratio, which corresponds to the ratio of cast-ins to fetch-hits for the cache in question. The lower the cast-in/fetch-hit ratio, the more likely that the data being persisted in the cache corresponds to data from a non-temporal workload.

In one embodiment, analyzing engine 302 determines if the workload is non-temporal based on comparing the values of such metrics to a threshold value, which may be user-designated. For example, the cache hit/miss ratio, the fetch/cast-out ratio, and/or the percentage of cast-outs with changed data may be compared against a threshold value, which may be user-designated. For instance, if the cache his/miss ratio is below a threshold value, then it may be inferred that the workload corresponds to a non-temporal workload. If the fetch/cast-out ratio exceeds a threshold value, then it may be inferred that the workload corresponds to a non-temporal workload. If the percentage of cast-outs with changed data exceeds a threshold value, then it may be inferred that the workload corresponds to a non-temporal workload.

In another example, the metric of the cast-in/fetch-hit ratio may be compared against a threshold value. If the cast-in/fetch-hit ratio is below a threshold value, then it may be inferred that the workload corresponds to a non-temporal workload.

In one embodiment, analyzing engine 302 analyzes the metrics of the monitored cache activities of the workload discussed above using various software tools, which can include, but are not limited to, Apple® Activity Monitor, IBM® Integrated Analytics System, Amazon® ElastiCache®, Perf tool in Linux®, VTune®, etc.

Furthermore, cache controller 206 includes tracking engine 303 configured to identify the cache lines(s) associated with the non-temporal workload.

In one embodiment, tracking engine 303 tracks the data streamed from the memory (e.g., main memory 207) by a workload, where a copy of such data is stored or cached in a cache (e.g., L1 cache 204) in the form of a cache line. The cache line contains the actual data that was fetched from the main memory, as well as a directory store, status information, and an effective memory address. By tracking the data streamed from the memory (e.g., main memory 207) by a workload as well as the cache lines loaded into the caches (e.g., L1 cache 204), tracking engine 303 is able to identify the cache line(s) associated with the workloads, including a non-temporal workload.

In one embodiment, tracking engine 303 performs such tracking using various software tools, which can include, but are not limited to, Perf tool in Linux®, Datadog®, Redis®, etc.

Additionally, cache controller 206 includes persistence policy engine 304 configured to alter the persistence policies, such as the persistence policy for the cache line(s) associated with the non-temporal workload. A persistence policy, as used herein, defines the rules used to determine how long data or a cache line can be persisted or stored in a cache (e.g., L1 cache 204).

In one embodiment, persistence policy engine 304 alters the persistence policy for the cache line(s) associated with the non-temporal workload, such as reducing the tenure (length of time data is stored in the cache) of such a cache line(s) in the cache (e.g., L1 cache 204). In one embodiment, persistence policy engine 304 reduces the tenure of the cache line(s) associated with the non-temporal workload via setting a particular value in a hint bit (bit that allows the tenure of the associated cache line to be known). By reducing the length of time the cache line(s) associated with non-temporal workloads are stored in the cache, such a cache will not be persisting data that will not be re-referenced for a great amount of time thereby reducing the number of cache misses or evictions. By reducing the number of cache misses or evictions, the effects of cache thrashing are minimized.

In another embodiment, persistence policy engine 304 alters the persistence policy for the cache line(s) associated with the non-temporal workload to cast-out (evict) the cache line(s) associated with the non-temporal workload. By casting out the cache line(s) from the cache (e.g., L1 cache 204) associated with the non-temporal workload, such a cache will not be storing data that will not be re-referenced thereby reducing the number of cache misses or evictions. By reducing the number of cache misses or evictions, the effects of cache thrashing are minimized.

In one embodiment, persistence policy engine 304 alters the persistence policy using various software tools, which can include, but are not limited to, CloudFront®, Amazon® ElastiCache®, Intel® Cache Acceleration Software, etc.

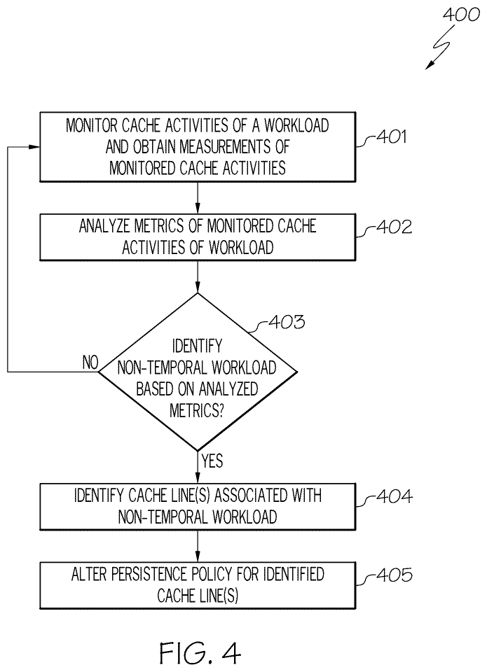

A discussion regarding the method for minimizing the effects of cache thrashing from a non-temporal workload is provided below in connection with FIG. 4.

FIG. 4 is a flowchart of a method 400 for minimizing the effects of cache thrashing involving a non-temporal workload in accordance with an embodiment of the present disclosure.

Referring to FIG. 4, in conjunction with FIGS. 1-3, in step 401, monitoring engine 301 of cache controller 206 monitors cache activities of a workload and obtains measurements of the monitored cache activities.

As discussed above, in one embodiment, monitoring engine 301 monitors the cache activities and obtains measurements of such monitored cache activities for local and peer caches (e.g., L1 cache 204, L2 cache 205).

A workload, as used herein, refers to the computational tasks, processes, or data transactions required to be performed by a program. Such tasks may correspond to streaming data from main memory 207. If the fetched data from main memory 207 is not already stored in the cache, and such data may likely be accessed in the near future, then a cache line containing the actual data that was fetched from main memory 207 is loaded into a cache (e.g., L1 cache 204, L2 cache 205) for future access. A cache line, as used herein, refers to a block of memory that a processor loads into a cache when it accesses a part of memory that is not already stored in the cache. The cache line contains the actual data that was fetched from main memory 207, as well as a directory store, status information, and an effective memory address.

In one embodiment, various cache activities are monitored and measured by monitoring engine 301, such as the data served, which corresponds to the total amount of data the cache (e.g., L1 cache 204, L2 cache 205) has served. Another example of a monitored and measured cache activity includes the amount of data the cache (e.g., L1 cache 204, L2 cache 205) has downloaded but did not add to its cache. A further example of a monitored and measured cache activity includes the data served from the origin, such as the amount of data the cache (e.g., L1 cache 204, L2 cache 205) downloaded over the Internet. Furthermore, a monitored and measured cache activity may include the data served from peers, such as the amount of data the cache (e.g., L1 cache 204, L2 cache 205) downloaded from any of its peer caches. Another example of cache activity that is monitored and measured includes the data served to clients, which may correspond to the amount of data the cache (e.g., L1 cache 204, L2 cache 205) served to the client computers/devices. A further example of cache activity that is monitored and measured includes the data served to peers, which may correspond to the amount of data served to any of its peer caches. An additional example of cache activity includes cache pressure, which corresponds to how urgently the cache (e.g., L1 cache 204, L2 cache 205) needs more disk space.

Other examples of cache activities that are monitored and measured by monitoring engine 301 include the number of cache hits and cache misses for a cache (e.g., L1 cache 204). A cache hit, as used herein, refers to when a cache can fulfill a request for data rather than having to retrieve the data, such as from main memory 207. That is, when there is a cache hit, the data is already stored in the cache and can be quickly and efficiently served to the user. A cache miss, as used herein, refers to when there is a request to retrieve data from a cache, but the requested data does not currently reside within the cache. Furthermore, in one embodiment, in connection with monitoring cache misses, monitoring engine 301 identifies the data sources of cache misses. Upon detecting a cache miss, monitoring engine 301 may utilize various software tools to identify the data sources of the cache misses, which can include, but are not limited to, Perf tool in Linux®, VTune®, etc.

Another example of a cache activity that is monitored and measured by monitoring engine 301 includes monitoring and measuring the number of fetches and cast-outs. A fetch, as used herein, refers to retrieving data from a source, such as main memory 207. A cast-out, as used herein, refers to evicting, removing, or flushing the data, including a cache line, from the cache, which may be written to memory (e.g., main memory 207). Furthermore, in one embodiment, monitoring engine 301 monitors and measures the percentage of cast-outs with change data. Casting out a changed data item refers to reading it from the cache (e.g., L1 cache 204) and writing it to memory (e.g., main memory 207). However, when you cast-out the data item from the cache (e.g., L1 cache 204), the data item is not deleted from the cache (e.g., L1 cache 204), but the data item remains in the cache (e.g., L1 cache 204).

Other examples of cache activities that are monitored and measured by monitoring engine 301 include cast-ins and fetch-hits. A cast-in, as used herein, refers to loading data, including a cache line, into the cache (e.g., L1 cache 204). A fetch-hit, as used herein, refers to a fetch call to fetch or retrieve data from a cache (e.g., L1 cache 204) resulting in a cache hit.

In one embodiment, monitoring engine 301 monitors and measures the various cache activities discussed above using various software tools, which can include, but are not limited to, Apple® Activity Monitor, IBM® Integrated Analytics System, Amazon® ElastiCache®, Perf tool in Linux®, VTune®, etc.

In step 402, analyzing engine 302 of cache controller 206 analyzes the metrics of the monitored cache activities of the workload.

As stated above, in one embodiment, analyzing engine 302 performs an analysis of the metrics of the monitored cache activity of the workload to determine if the workload is non-temporal. A “non-temporal workload,” as used herein, refers to a workload that persists data that is not going to be reused (read again) soon, such as before it gets evicted (cast-out). As a result, there is no benefit in persisting such data in the cache(s) and there may be a penalty if the stored data displaces other useful data from the cache(s). In one embodiment, such a non-temporal workload may be identified based on analyzing cache activity metrics for local and peer caches, such as the cache hit/miss ratio, the cache miss data sources, the fetch/cast-out ratio, and the percentage of cast-outs with changed data.

The cache hit/miss ratio refers to the ratio of cache hits to cache misses for the cache in question (e.g., L1 cache 204). The cache miss data sources refer to the data sources of the cache misses that were identified by monitoring engine 301. The fetch/cast-out ratio refers to the ratio of fetches to cast-outs for the cache in question. The percentage of cast-outs with changed data refers to the percentage of cast-outs that involved changed data.

As discussed above, the analysis of such metrics may indicate if the workload is a non-temporal workload. For example, the lower the cache hit/miss ratio, the higher the fetch/cast-out ratio, and the higher the percentage of cast-outs with changed data (casting out a changed data item results in reading the changed data item from the cache structure and writing it to permanent storage without deleting the data item from the cache structure), the more likely that the data being persisted in the cache corresponds to non-temporal workload data. Furthermore, cache miss data sources may indicate that the data being stored in the cache(s) (e.g., L1 cache 204) corresponds to non-temporal data from a non-temporal workload. For instance, an algorithm that performs transformations on data streams, such as reading the data once from one location and writing it once to another location, may result in no data reuses. In another example, an algorithm that runs on a data set that does not fit in the cache will result in no data reuses.

Furthermore, in one embodiment, the analysis of the metrics of the monitored cache activity of the workload to determine if the workload is non-temporal may include metrics resulting from feedback provided from peer caches, such as cast-ins and fetch-hits. Such metrics may be analyzed by analyzing engine 302 in the form of a cast-in/fetch-hit ratio, which corresponds to the ratio of cast-ins to fetch-hits for the cache in question. The lower the cast-in/fetch-hit ratio, the more likely that the data being persisted in the cache corresponds to data from a non-temporal workload.

In one embodiment, analyzing engine 302 analyzes the metrics of the monitored cache activities of the workload discussed above using various software tools, which can include, but are not limited to, Apple® Activity Monitor, IBM® Integrated Analytics System, Amazon® ElastiCache®, Perf tool in Linux®, VTune®, etc.

In step 403, analyzing engine 302 of cache controller 206 determines if a non-temporal workload was identified based on the analysis of the metrics of the monitored cache activities of the workload.

In one embodiment, such a determination is made by analyzing engine 302 based on comparing one or more metrics of the monitored cache activities of the workload to a threshold value, which may be user-designated. For example, the cache hit/miss ratio, the fetch/cast-out ratio, and/or the percentage of cast-outs with changed data may be compared against a threshold value, which may be user-designated. For instance, if the cache his/miss ratio is below a threshold value, then it may be inferred that the workload corresponds to a non-temporal workload. If the fetch/cast-out ratio exceeds a threshold value, then it may be inferred that the workload corresponds to a non-temporal workload. If the percentage of cast-outs with changed data exceeds a threshold value, then it may be inferred that the workload corresponds to a non-temporal workload.

In another example, the metric of the cast-in/fetch-hit ratio may be compared against a threshold value. If the cast-in/fetch-hit ratio is below a threshold value, then it may be inferred that the workload corresponds to a non-temporal workload.

In a further example, the cache miss data sources may indicate that the data being stored in the cache(s) (e.g., L1 cache 204) corresponds to non-temporal data from a non-temporal workload. For instance, an algorithm that performs transformations on data streams, such as reading the data once from one location and writing it once to another location, may result in no data reuses. In another example, an algorithm that runs on a data set that does not fit in the cache will result in no data reuses.

If a non-temporal workload was not identified based on the analysis of the metrics of the monitored cache activities of the workload, then monitoring engine 301 of cache controller 206 continues to monitor the cache activities of a workload and obtain measurements of the monitored cache activities in step 401.

If, however, a non-temporal workload was identified based on the analysis of the metrics of the monitored cache activities of the workload, then, in step 404, tracking engine 303 of cache controller 206 identifies the cache lines(s)associated with the non-temporal workload.

As stated above, in one embodiment, tracking engine 303 tracks the data streamed from the memory (e.g., main memory 207) by a workload, where a copy of such data is stored or cached in a cache (e.g., L1 cache 204) in the form of a cache line. The cache line contains the actual data that was fetched from the main memory, as well as a directory store, status information, and an effective memory address. By tracking the data streamed from the memory (e.g., main memory 207) by a workload as well as the cache lines loaded into the caches (e.g., L1 cache 204), tracking engine 303 is able to identify the cache line(s) associated with the workloads, including a non-temporal workload.

In one embodiment, tracking engine 303 performs such tracking using various software tools, which can include, but are not limited to, Perf tool in Linux®, Datadog®, Redis®, etc.

In step 405, persistence policy engine 304 of cache controller 206 alters the persistence policies, such as the persistence policy for the cache line(s) associated with the non-temporal workload. A persistence policy, as used herein, defines the rules used to determine how long data or a cache line can be persisted or stored in a cache (e.g., L1 cache 204).

As discussed above, in one embodiment, persistence policy engine 304 alters the persistence policy for the cache line(s) associated with the non-temporal workload, such as reducing the tenure (length of time data is stored in the cache) of such a cache line(s) in the cache (e.g., L1 cache 204). In one embodiment, persistence policy engine 304 reduces the tenure of the cache line(s) associated with the non-temporal workload via setting a particular value in a hint bit (bit that allows the tenure of the associated cache line to be known). By reducing the length of time the cache line(s) associated with non-temporal workloads are stored in the cache, such a cache will not be persisting data that will not be re-referenced for a great amount of time thereby reducing the number of cache misses or evictions. By reducing the number of cache misses or evictions, the effects of cache thrashing are minimized.

In another embodiment, persistence policy engine 304 alters the persistence policy for the cache line(s) associated with the non-temporal workload to cast-out (evict) the cache line(s) associated with the non-temporal workload. By casting out the cache line(s) from the cache (e.g., L1 cache 204) associated with the non-temporal workload, such a cache will not be storing data that will not be re-referenced thereby reducing the number of cache misses or evictions. By reducing the number of cache misses or evictions, the effects of cache thrashing are minimized.

In one embodiment, persistence policy engine 304 alters the persistence policy using various software tools, which can include, but are not limited to, CloudFront®, Amazon® ElastiCache®, Intel® Cache Acceleration Software, etc.

In this manner, the effects of cache thrashing from a non-temporal workload are minimized.

Furthermore, the principles of the present disclosure improve the technology or technical field involving cache thrashing in caching mechanisms.

As discussed above, cache thrashing may occur when workloads stream large amounts of data from memory. A workload refers to the computational tasks, processes, or data transactions required to be performed by a program. Examples of such workloads that stream large amounts of data from memory include streaming real-time data, such as location, stock prices, information technology system monitoring, fraud detection, retail inventory, sales, customer activity, etc. Workloads that stream large amounts of data from memory (e.g., main memory) may negatively impact the overall system performance by thrashing multiple cache levels, such as by constantly updating a cache with new data or repeatedly accessing data that is larger than the cache size. As a result, the number of cache misses or data evictions may increase thereby resulting in the processor accessing the slower main memory to fetch the requested data. Furthermore, such workloads may consume system resources to persist data (referring to storing data in a cache for a period of time) in the cache that will not be re-referenced. As a result, the number of cache misses or data evictions may increase thereby resulting in the processor accessing the slower main memory to fetch the requested data. Techniques have been developed to attempt to address cache thrashing. For example, one such technique is to use different cache levels or partitions to reduce cache contention. In another example, the cache size is attempted to be optimized. For instance, after determining the cache size, large amounts of data is split into smaller blocks that can fit inside the cache. Another technique is to optimize the cache replacement policy, such as by matching the policy to the workload. Furthermore, a cache-aside pattern may be used to address cache thrashing. For example, a microservice check may be used to determine if data is available in the cache before accessing it. Despite these techniques to address cache thrashing, such techniques do not address the effects of cache thrashing involving the situation when workloads stream large amounts of data from memory (e.g., main memory) which negatively impacts the overall system performance by thrashing multiple cache levels and consumes system resources to persist data in the cache that will not re-referenced.

Embodiments of the present disclosure improve such technology by monitoring the cache activities of a workload, including the cache activities involving local and peer caches. Examples of such activities include the number of cache hits and cache misses for a cache, the number of fetches and cast-outs, the amount of data the cache has downloaded but did not add to its cache, etc. Based on analyzing the metrics of such monitored cache activities, a determination is made as to whether a non-temporal workload is identified. A “non-temporal workload,” as used herein, refers to a workload that persists data that is not going to be reused (read again) soon, such as before it gets evicted (cast-out). As a result, there is no benefit in persisting such data in the cache(s) and there may be a penalty if the stored data displaces other useful data from the cache(s). In one embodiment, such a determination is based on comparing the metrics of the monitored cache activities of the workload to a threshold value, which may be user-designated. For example, the cache hit/miss ratio, the fetch/cast-out ratio, and/or the percentage of cast-outs with changed data may be compared against a threshold value, which may be user-designated. For instance, if the cache his/miss ratio is below a threshold value, then it may be inferred that the workload corresponds to a non-temporal workload. Upon identifying a non-temporal workload, the cache line(s) associated with the non-temporal workload are identified. The persistence policy for the identified cache line(s) is then altered. A persistence policy, as used herein, defines the rules used to determine how long data or a cache line can be persisted or stored in a cache. In one embodiment, the persistence policy for the cache line(s) associated with the non-temporal workload is altered by reducing the tenure (length of time data is stored in the cache) of such a cache line(s) in the cache. By reducing the length of time the cache line(s) associated with non-temporal workloads are stored in the cache, such a cache will not be persisting data that will not be re-referenced for a great amount of time thereby reducing the number of cache misses or evictions. By reducing the number of cache misses or evictions, the effects of cache thrashing are minimized. In another embodiment, the persistence policy for the cache line(s) associated with the non-temporal workload is altered by casting-out (evicting) the cache line(s) associated with the non-temporal workload. By casting out the cache line(s) from the cache associated with the non-temporal workload, such a cache will not be storing data that will not be re-referenced thereby reducing the number of cache misses or evictions. By reducing the number of cache misses or evictions, the effects of cache thrashing are minimized. In this manner, the effects of cache thrashing from a non-temporal workload are minimized. Furthermore, in this manner, there is an improvement in the technical field involving cache thrashing in caching mechanisms.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for minimizing effects of cache thrashing, the method comprising:
monitoring cache activity of a workload;
identifying a non-temporal workload based on said monitored cache activity of said workload;
identifying one or more cache lines associated with said non-temporal workload; and
altering a persistence policy for said one or more cache lines associated with said non-temporal workload.

2. The method as recited in claim 1, wherein said persistence policy is altered to reduce a tenure of said one or more cache lines.

3. The method as recited in claim 2, wherein said persistence policy is altered to reduce said tenure of said one or more cache lines via setting a particular value in a hint bit.

4. The method as recited in claim 1, wherein said persistence policy is altered to cast-out said one or more cache lines directly to memory.

5. The method as recited in claim 1 further comprising:
analyzing metrics of said monitored cache activity of said workload.

6. The method as recited in claim 5, wherein said metrics of said monitored cache activity of said workload comprise one or more of the following selected from the group consisting of: cache hit/miss ratio, cache miss data sources, fetch/cast-out ratio, and percentage of cast-outs with changed data.

7. The method as recited in claim 5, wherein said cache activity of said workload is monitored in connection with a peer cache, wherein said metrics of said monitored cache activity of said workload comprise a cast-in/fetch-hit ratio provided by said peer cache.

8. The method as recited in claim 1, wherein said cache activity of said workload is monitored in connection with local caches and peer caches.

9. The method as recited in claim 1, wherein said workload streams data from a memory.

10. A computer program product for minimizing effects of cache thrashing, the computer program product comprising one or more computer readable storage mediums having program code embodied therewith, the program code comprising programming instructions for:
monitoring cache activity of a workload;
identifying a non-temporal workload based on said monitored cache activity of said workload;
identifying one or more cache lines associated with said non-temporal workload; and
altering a persistence policy for said one or more cache lines associated with said non-temporal workload.

11. The computer program product as recited in claim 10, wherein said persistence policy is altered to reduce a tenure of said one or more cache lines.

12. The computer program product as recited in claim 11, wherein said persistence policy is altered to reduce said tenure of said one or more cache lines via setting a particular value in a hint bit.

13. The computer program product as recited in claim 10, wherein said persistence policy is altered to cast-out said one or more cache lines directly to memory.

14. The computer program product as recited in claim 10, wherein the program code further comprises the programming instructions for:
analyzing metrics of said monitored cache activity of said workload.

15. The computer program product as recited in claim 14, wherein said metrics of said monitored cache activity of said workload comprise one or more of the following selected from the group consisting of: cache hit/miss ratio, cache miss data sources, fetch/cast-out ratio, and percentage of cast-outs with changed data.

16. The computer program product as recited in claim 14, wherein said cache activity of said workload is monitored in connection with a peer cache, wherein said metrics of said monitored cache activity of said workload comprise a cast-in/fetch-hit ratio provided by said peer cache.

17. The computer program product as recited in claim 10, wherein said cache activity of said workload is monitored in connection with local caches and peer caches.

18. A system, comprising:
a memory for storing a computer program for minimizing effects of cache thrashing; and
a processor connected to said memory, wherein said processor is configured to execute program instructions of the computer program comprising:
monitoring cache activity of a workload;
identifying a non-temporal workload based on said monitored cache activity of said workload;
identifying one or more cache lines associated with said non-temporal workload; and
altering a persistence policy for said one or more cache lines associated with said non-temporal workload.

19. The system as recited in claim 18, wherein said persistence policy is altered to reduce a tenure of said one or more cache lines.

20. The system as recited in claim 19, wherein said persistence policy is altered to reduce said tenure of said one or more cache lines via setting a particular value in a hint bit.

21. The system as recited in claim 18, wherein said persistence policy is altered to cast-out said one or more cache lines directly to memory.

22. The system as recited in claim 18, wherein the program instructions of the computer program further comprise:
analyzing metrics of said monitored cache activity of said workload.

23. The system as recited in claim 22, wherein said metrics of said monitored cache activity of said workload comprise one or more of the following selected from the group consisting of: cache hit/miss ratio, cache miss data sources, fetch/cast-out ratio, and percentage of cast-outs with changed data.

24. The system as recited in claim 22, wherein said cache activity of said workload is monitored in connection with a peer cache, wherein said metrics of said monitored cache activity of said workload comprise a cast-in/fetch-hit ratio provided by said peer cache.

25. The system as recited in claim 18, wherein said cache activity of said workload is monitored in connection with local caches and peer caches.
